(19) United States
(12) Patent Application Publication
(10) Pub. No.: US 2017/0259405 A1
(43) Pub. Date: Sep. 14, 2017

(54) VISE

(71) Applicants: CHANG-YI LIN, Taichung City (TW); CHANG-CHIH LIN, Taichung City (TW)

(72) Inventors: CHANG-YI LIN, Taichung City (TW); CHANG-CHIH LIN, Taichung City (TW)

(21) Appl. No.: 15/235,569

(22) Filed: Aug. 12, 2016

(30) Foreign Application Priority Data
Mar. 9, 2016 (TW) 105107266

(51) Int. Cl. B25B 1/08; B23Q 3/06

(52) U.S. Cl. CPC B25B 1/08; B23Q 3/066

(57) ABSTRACT

A vise is provided, including: a pushing block, including at least one pushing side, each said pushing side including at least one first pushing abutting inclined surface and at least one first restriction structure, each said first restriction structure having a first sliding abutting inclined surface; at least one clamping block, each said clamping block including at least one second restriction structure, each said second restriction structure including at least one second sliding abutting inclined surface, the at least one second restriction structure of each said clamping block slidably restrictable with the at least one first restriction structure, each said second restriction structure and one said first restriction structure restrictably abutting against each other and non-detachable on a direction perpendicular to a sliding path of the clamping block, the second sliding abutting inclined surface parallel to the first sliding abutting inclined surface.

### BACKGROUND OF THE INVENTION

Field of the Invention

The present invention relates to a fixing tool, and more particularly to a vise.

Description of the Prior Art

A common vise can be used to fix an object, the vise continues to abut against the object tightly to stably fix the object for further processing operations. An urging and labor-saving structure for vise as disclosed in TWM311528 is this type of vise.

However, in the prior arts, a fixing base and a movable base may be tilted due to improper or uneven force application, and the fixing base and the movable base may be abraded or damaged. In addition, because the fixing base and the movable base are not stably connected to each other, the fixing base and the movable base are easily detachable from each other.

The present invention has arisen to mitigate and/or obviate the afore-described disadvantages.

### SUMMARY OF THE INVENTION

The major object of the present invention is to provide a vise, which has a simple and stable structure.

To achieve the above and other objects, a vise is provided, including: a pushing block, including at least one pushing side, each said pushing side including at least one first pushing abutting inclined surface and at least one first restriction structure, a side of each said first restriction structure remote from the first pushing abutting inclined surface having a first sliding abutting inclined surface which has an inclination direction as same as a inclination direction of the first pushing abutting inclined surface; at least one clamping block, each said clamping block including at least one second restriction structure, each said second restriction structure including at least one second sliding abutting inclined surface, the at least one second restriction structure of each said clamping block being slidably restrictable with the at least one first restriction structure, each said second restriction structure and one said first restriction structure restrictably abutting against each other and being non-detachable in a direction perpendicular to a sliding path of the clamping block, the second sliding abutting inclined surface being parallel to the first sliding abutting inclined surface.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferred embodiment of the present invention;

FIG. 2 is a partially breakdown view of the first preferred embodiment of the present invention;

FIG. 3 is a breakdown view of the first preferred embodiment of the present invention;

FIG. 4 is a drawing showing the first preferred embodiment of the present invention in use;

FIG. 5 is a cross-sectional side view of FIG. 4;

FIG. 6 is a partially-enlarged view of FIG. 5;

FIG. 7 is another drawing showing the first preferred embodiment of the present invention in use;

FIG. 8 is a cross-sectional side view of FIG. 7;

FIG. 9 is a partially-enlarged view of FIG. 8;

FIG. 10 is a drawing showing a second preferred embodiment of the present invention in use;

FIG. 11 is a partially breakdown view of a third preferred embodiment of the present invention;

FIG. 12 is a partial view of a fourth preferred embodiment of the present invention;

FIG. 13 is partially-enlarged view of a fifth preferred embodiment of the present invention; and

FIG. 14 is a drawing showing a sixth preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

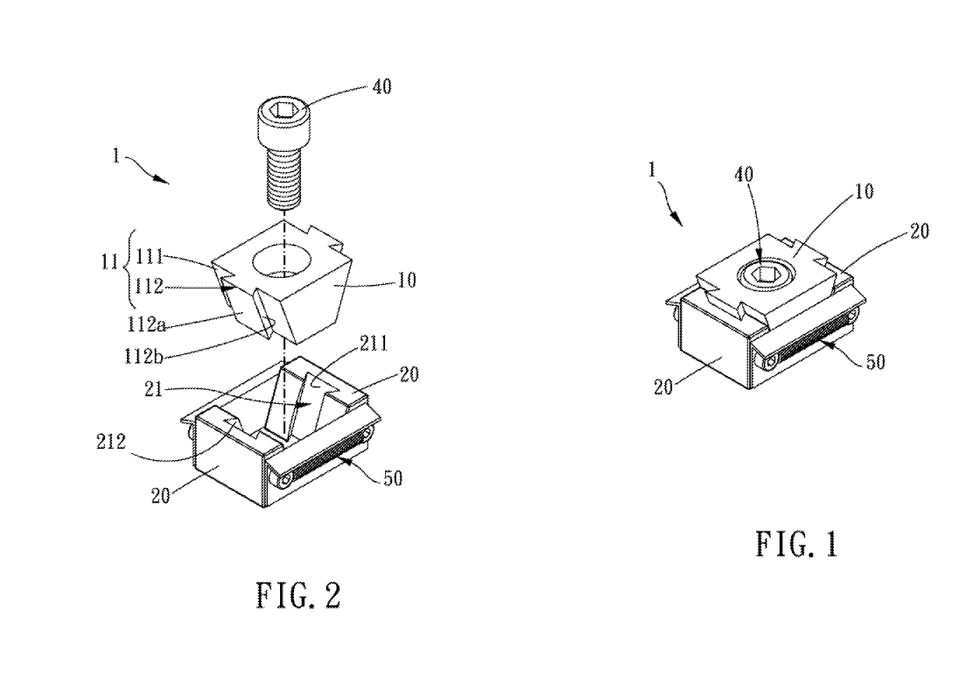

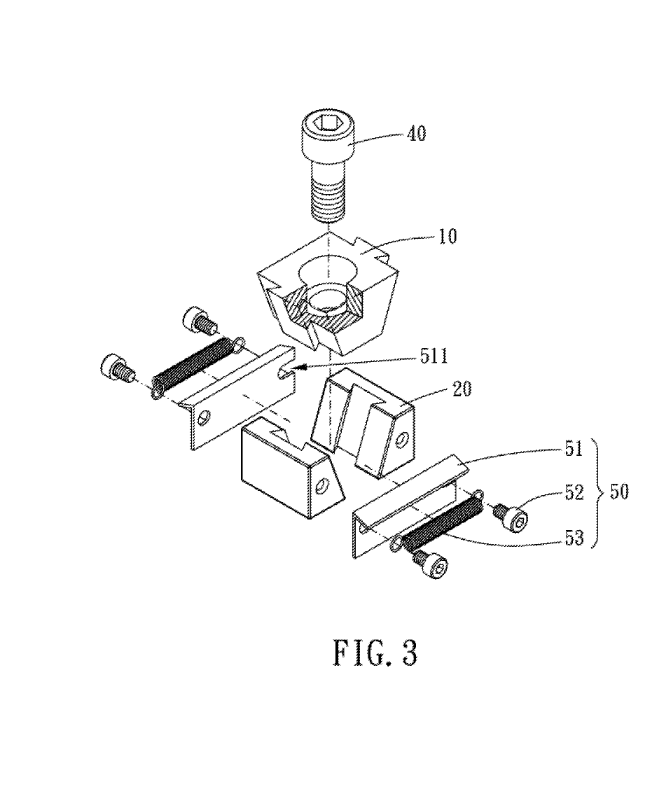

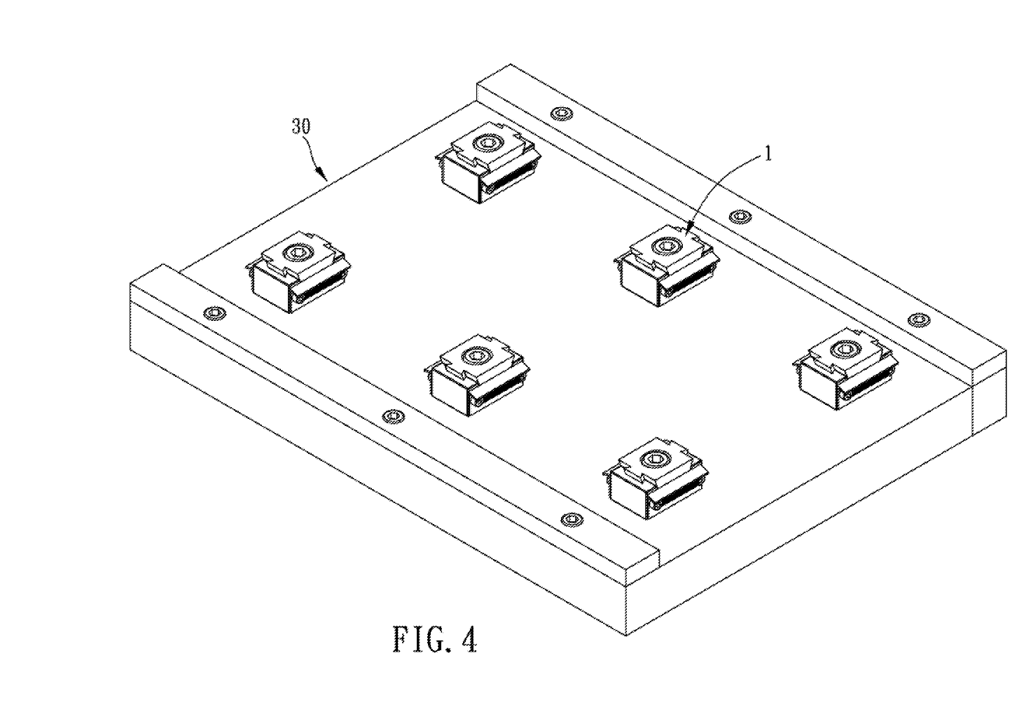

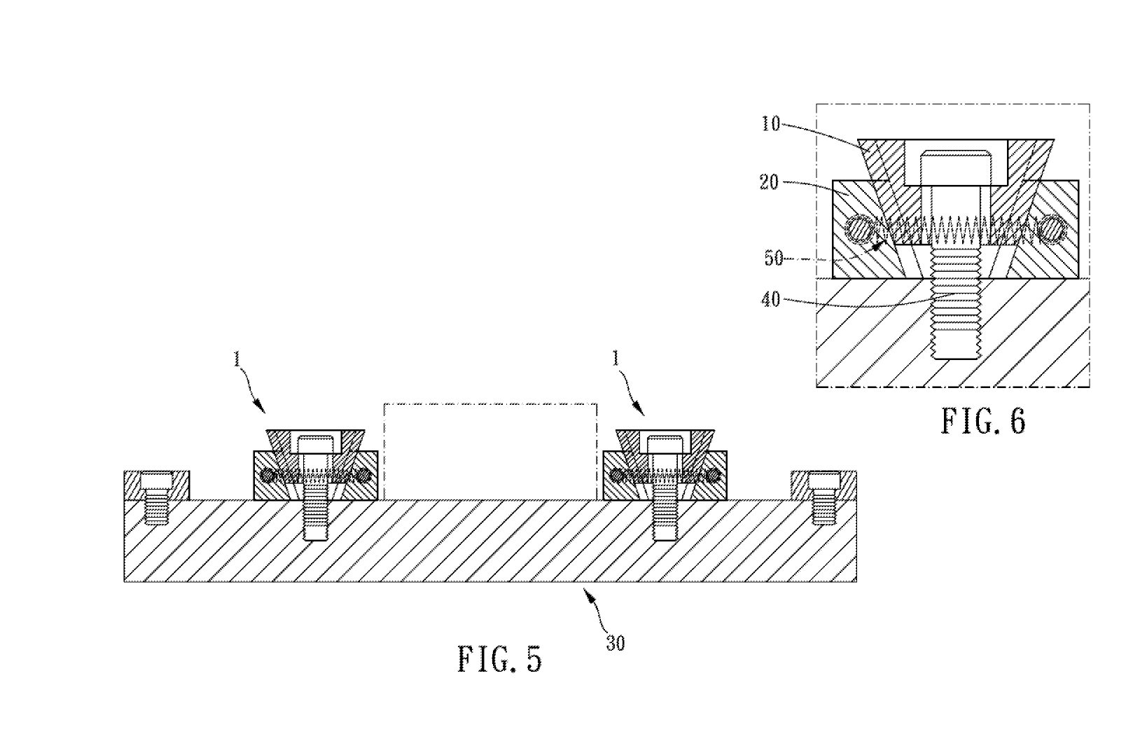

Please refer to FIGS. 1 to 5 for a preferred embodiment of the present invention. A vise 1 includes a pushing block 10 and at least one clamping block 20.

The pushing block 10 includes at least one pushing side 11, each said pushing side 11 includes at least one first pushing abutting inclined surface 111 and at least one first restriction structure. In this embodiment, the first restriction structure is a head-neck protrusion 112, a side of the head-neck protrusion 112 (the first restriction structure) remote from the first pushing abutting inclined surface 111 has a first sliding abutting inclined surface 1112a which has an inclination direction as same as a inclination direction of the first pushing abutting inclined surface 111. Each said clamping block 20 includes at least one second restriction structure, and in this embodiment, the second restriction structure is a neck-expanded bottom sliding slot 21, each said neck-expanded bottom sliding slot 21 (the second restriction structure) includes at least one second sliding abutting inclined surface 211. The at least one second restriction structure of each said clamping block 20 is slidably restrictable with the at least one first restriction structure, each said second restriction structure and one said first restriction structure restrictably abut against each other and are non-detachable in a direction perpendicular to a sliding path of the clamping block 20, and the second sliding abutting inclined surface 211 is parallel to the first sliding abutting inclined surface 112a. Specifically, each said head-neck protrusion 112 slidably abuts against the first sliding abutting inclined surface 112a via the second sliding abutting inclined surface 211 in parallel and is slidably restricted within one said neck-expanded bottom sliding slot 21 so that there is no need of any element to prevent the pushing block 10 and the clamping block 20 from being detached from each other. The pushing block 10 can push the clamping block 20 to make the clamping block 20 move forward or backward in a fixed direction, and if a blocking body or another said vise is fixedly arranged on a position in a distance from the clamping block 20, an object can be clamped through the above-mentioned movement. In addition, the pushing block 10 and the clamping block 20 can be tightly slidably engaged with each other through the head-neck protrusion 112 and the neck-expanded bottom sliding slot 21 so that when the pushing block 10 is pushed to move the clamping block 20, the clamping block 20 will not move in other directions.

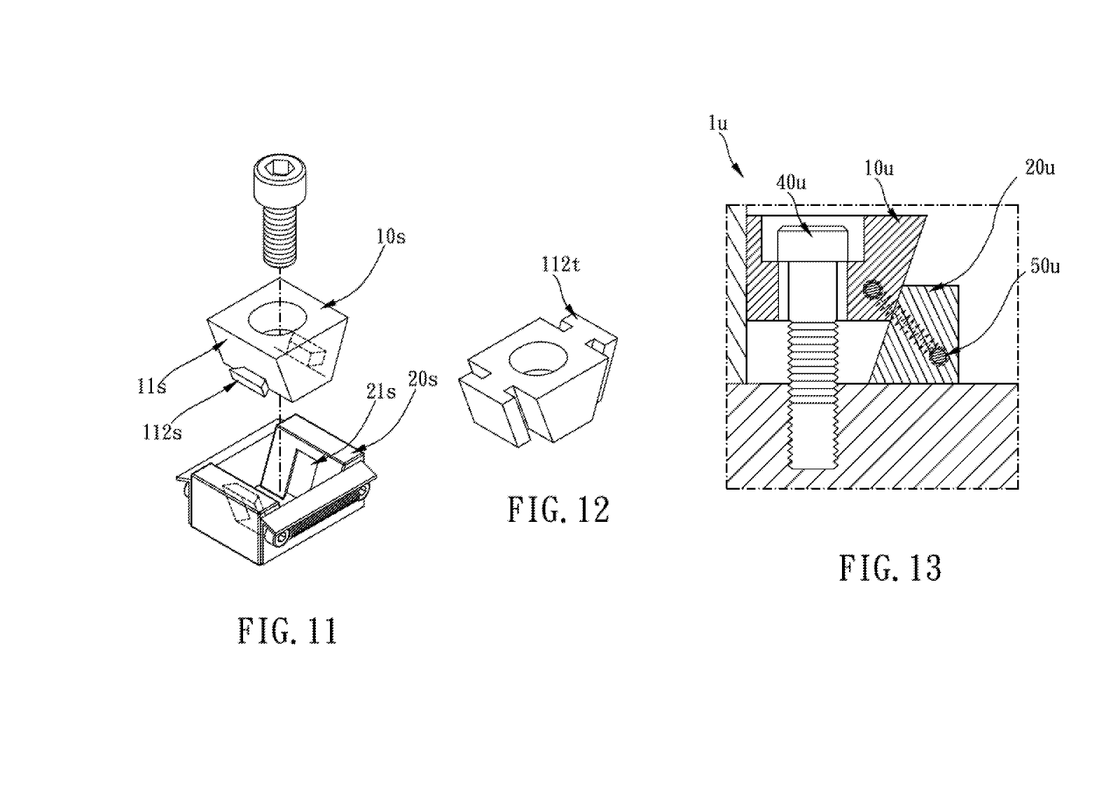

In this embodiment, two opposite sides of the pushing block 10 respectively have one said pushing side 11, a number of the at least one clamping block 20 is two, and the two pushing sides 11 tilt in directions which are axially corresponded so that the clamping block 20 can move forward or backward simultaneously. The head-neck protrusion 112 in this embodiment is a dovetail protrusion, each said head-neck protrusion 112 extends from one of two sides of one said pushing side 11 to another side opposite thereto, and each neck-expanded bottom sliding slot 21 penetrates from a side surface of one said clamping block 20 to another side surface opposite thereto (as shown in FIG. 2) so that the pushing block 10 and the clamping block 20 will not move in other directions during the movement. However, in a third embodiment (as shown in FIG. 11), each said head-neck protrusion 112s extends from one of two sides of one said pushing side 11 s without reaching another side opposite thereto, and each neck-expanded bottom sliding slot 21s forms on a side surface of one said clamping block 20s without reaching another side surface opposite thereto so that when the pushing block 10s moves upward, the head-neck protrusion 112s and the neck-expanded bottom sliding slot 21s are not detachable from each other. For example, a head-neck protrusion 112s only extends for a small distance upward from a side of a bottom portion of one said pushing side 11s, and a side of a neck-expanded bottom sliding slot 21s is not opened at a top side of a clamping block 20; therefore, after the head-neck protrusion 112s moves upward for a distance, the head-neck protrusion 112s abuts against and is blocked by a part of the top portion of the clamping block 20s so that the pushing block 10s and the clamping block 20s will not detachable from each other. It is to be noted that a protrusion of a pushing block and a sliding slot of at least one clamping block may be in other shapes. For example, the protrusion 112t may be a rectangular head-neck protrusion, and the sliding slot corresponds to the protrusion 112t in shape (as shown in FIG. 12).

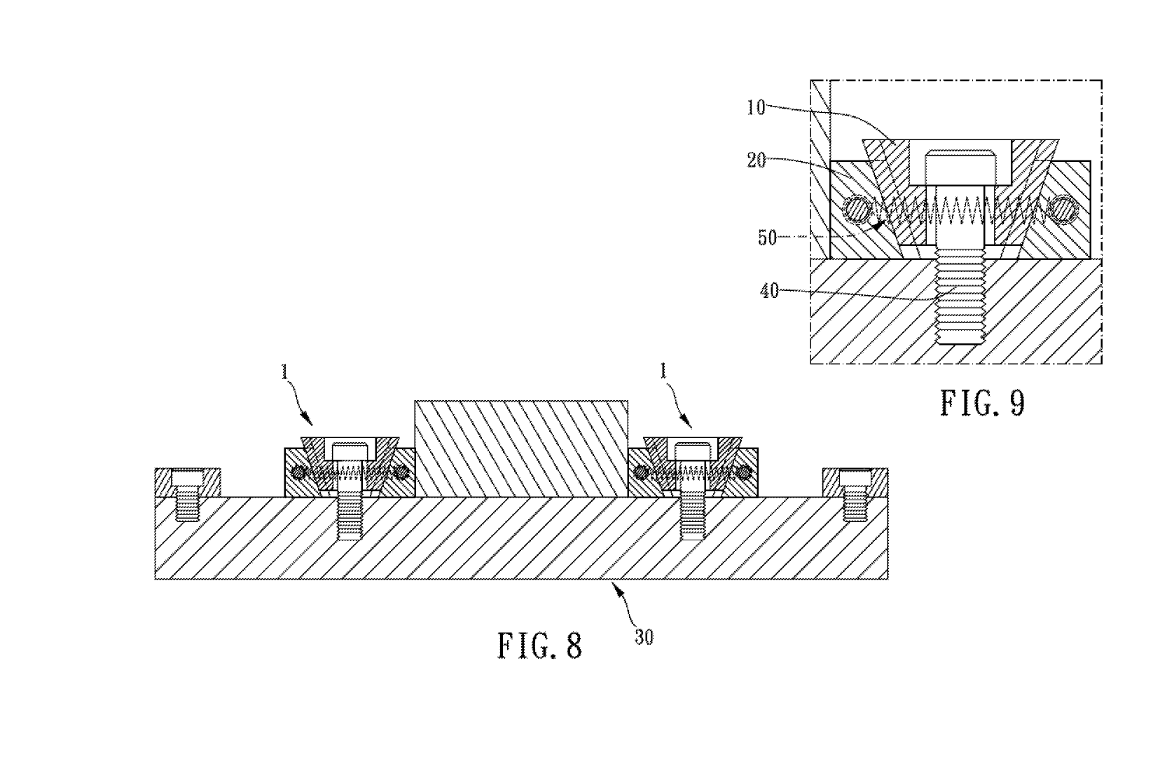

Please further refer to FIGS. 1 to 9. Each said head-neck protrusion 112 further includes two first lateral sliding abutting inclined surfaces 112b which are tapered relatively from two opposite sides of the first sliding abutting inclined surface 112a toward the first pushing abutting inclined surface 111, and two opposite sides of a slot wall of each said neck-expanded bottom sliding slot 21 further include two second lateral sliding abutting inclined surfaces 212 which respectively abut against the first lateral sliding abutting inclined surface 112b of each said head-neck protrusion 112 parallel so that the pushing block 10 and the clamping block 20 are slidable relative to a fixed direction.

The vise 1 further includes a platform 30 and an adjusting mechanism 40 which is for being adjustably disposed on the platform 30, the adjusting mechanism 40 abuts against the pushing block 10 and is capable of actuating the pushing block 10 to move relative to the platform 30 in a direction, and the direction is defined as a direction as same as the inclination direction toward the platform 30. In this embodiment, the adjusting mechanism 40 is threaded and penetrates a center of the pushing block 10 to be screwed to the platform 30 (as shown in FIG. 6 or 9), the pushing block 10 can move upward or downward through rotation of the adjusting mechanism 40 so as to change a moving distance of each said clamping block 20. In other embodiments, a fixing member which is substantially n-shaped is further provided, the fixing member is fixed on a platform and covers on a vise (that is, the vise is located between the fixing member and the platform), and an adjusting mechanism connects the fixing member and a pushing block of the vise so that a user can adjust the adjusting mechanism to move the pushing block upward or downward to change a moving distance of the vise.

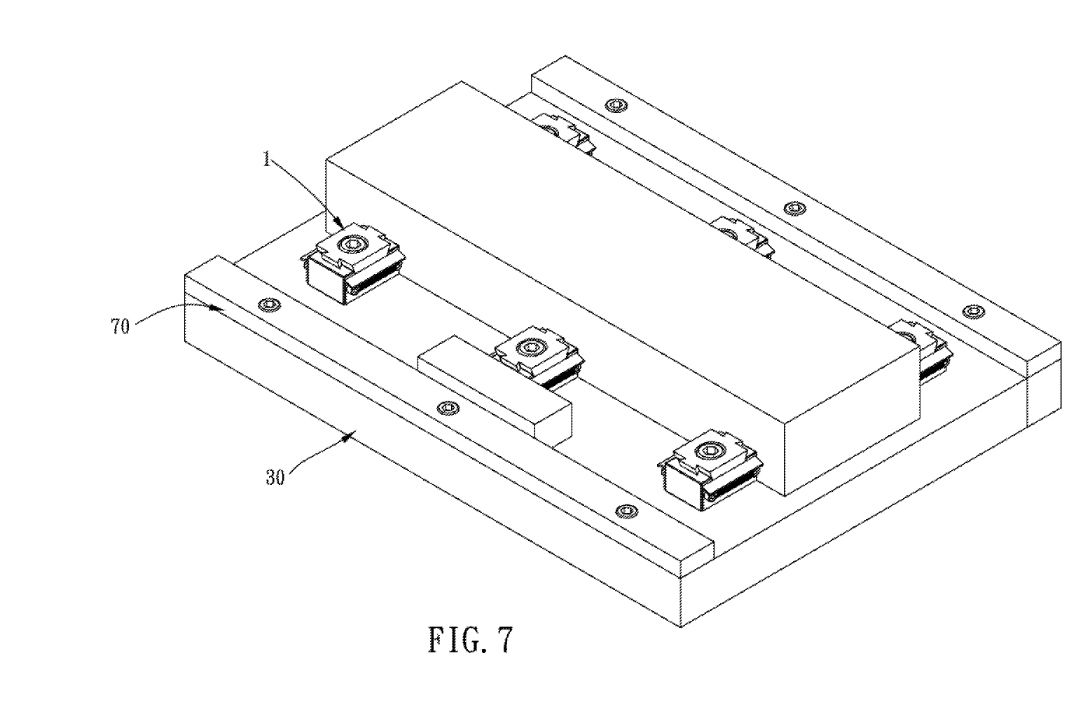

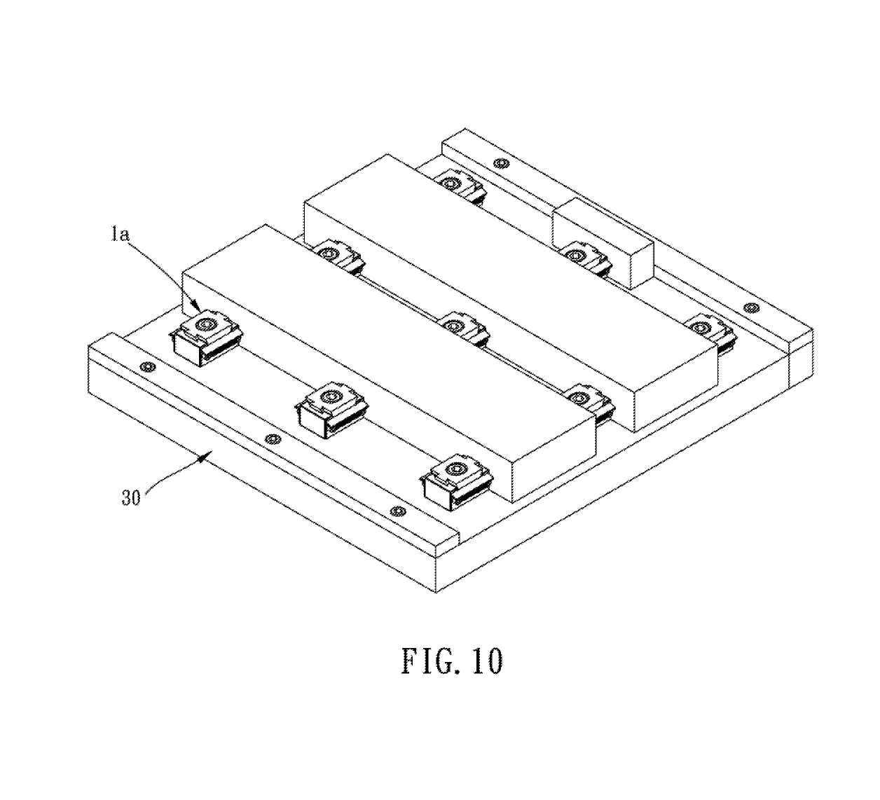

In this embodiment, the vise 1 further includes two elastic mechanisms 50, the two elastic mechanisms 50 connect the two clamping blocks 20 and are respectively arranged on two sides of the vise 1 to reinforce a stability between the pushing block 10 and the clamping block 20 to prevent the vise 1 from shaking and to decrease an abrasion between the pushing block 10 and the clamping block 20. The elastic mechanism 50 includes at least one side board 51, at least two fixing members 52 and at least one elastic member 53, each side board 51 has an open slot 511, one of the two fixing members 52 fixes one said side board 51 and one of two ends of one said elastic member 53 to one said clamping block 20, and the other of the two fixing members 52 fixes the other of the two ends of the elastic member 53 to another said clamping block 20 and is slidably arranged within the open slot 511 of the side board 51 without restricting a moving distance of the two clamping blocks 20. The two clamping blocks 20 allows the vise 1 to clamp a plurality of objects with a blocking block 70 and another vise, for example, the vise 1 can clamp a large object and a small object at the same time (as shown in FIG. 7), or in a second embodiment, a vise 1a can clamp a plurality of large objects and a plurality of small objects (as shown in FIG. 10). In a fifth embodiment, a vise 1u may have only one elastic structure 50u, and the elastic mechanism 50u may not have the side board (as shown in FIG. 13).

In the fifth embodiment (as shown in FIG. 13), an elastic mechanism 50u may assist a vise 1u to make a clamping block 20u to move backward automatically so that the clamping block 20u can retract conveniently. Specifically, a number of the clamping block 20u is one, an elastic mechanism 50u connects a pushing block 10u and the clamping block 20u, and an adjusting mechanism 40u abuts against the pushing block 10u and makes the pushing block 10u move upward or downward to push the clamping block 20u to fixedly clamp the object. Preferably, a platform has a plurality of slot holes for the user to adjust positions of the plurality of vises on the platform according to his/her needs. For example, if an object to be clamped is substantially L-shaped, the user can adjust the positions of the plurality of vises and arrange the vises along an edge of the object to be clamped which is substantially L-shaped so as to clamp the object firmly.

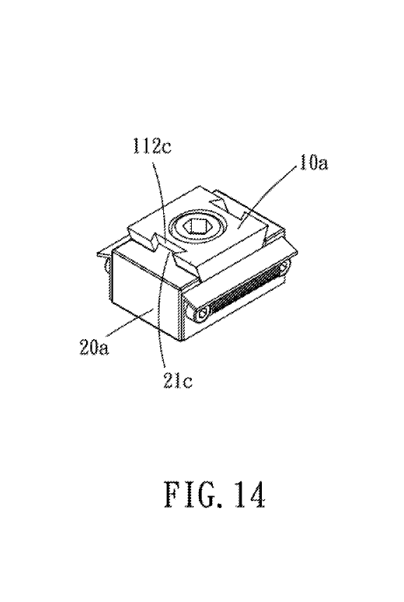

It is understandable that in a sixth embodiment (as shown in FIG. 14), a first restriction structure of the vise may be a neck-expanded bottom sliding slot 112c, the second restriction structure may be a head-neck protrusion 21c, and the first and second restriction structures 112c, 21c have the same restriction effect as the pushing block 10a and the clamping block 20a do.

Given the above, the first restriction structure such as the head-neck protrusion and the second restriction structure such as the neck-expanded bottom sliding slot have preferable restriction effect, and the first restriction structure and the second restriction structure can cooperate with the elastic mechanism for more stability. Furthermore, an abutting structure may be arranged in a relative sliding direction of the head-neck protrusion and the neck-expanded bottom sliding slot so that the vise is not easily detachable. The platform having the plurality of slot holes may be further provided so that the user can adjust the position of the vise to clamp objects in other shapes.

While we have shown and described various embodiments in accordance with the present invention, it should be clear to those skilled in the art that further embodiments may be made without departing from the scope of the present invention.

What is claimed is:

1. A vise, including:
a pushing block, including at least one pushing side, each said pushing side including at least one first pushing abutting inclined surface and at least one first restriction structure, a side of each said first restriction structure remote from the first pushing abutting inclined surface having a first sliding abutting inclined surface which has an inclination direction as same as a inclination direction of the first pushing abutting inclined surface;
at least one clamping block, each said clamping block including at least one second restriction structure, each said second restriction structure including at least one second sliding abutting inclined surface, the at least one second restriction structure of each said clamping block being slidably restrictable with the at least one first restriction structure, each said second restriction structure and one said first restriction structure restrictably abutting against each other and being non-detachable in a direction perpendicular to a sliding path of the clamping block, the second sliding abutting inclined surface being parallel to the first sliding abutting inclined surface.

2. The vise of claim 1, wherein the first restriction structure is a head-neck protrusion, and the second restriction structure is a neck-expanded bottom sliding slot.

3. The vise of claim 2, wherein each said head-neck protrusion further includes two first lateral sliding abutting inclined surfaces which are tapered relatively from two opposite sides of the first sliding abutting inclined surface toward the first pushing abutting inclined surface, and two opposite sides of a slot wall of each said neck-expanded bottom sliding slot further include two second lateral sliding abutting inclined surfaces which respectively abut against the first lateral sliding abutting inclined surface of each said head-neck protrusion parallel.

4. The vise of claim 2, wherein each said head-neck protrusion extends from one of two sides of one said pushing side to another side opposite thereto, and each neck-expanded bottom sliding slot penetrates from a side surface of one said clamping block to another side surface opposite thereto.

5. The vise of claim 2, wherein each said head-neck protrusion extends from one of two sides of one said pushing side without reaching another side opposite thereto, and each neck-expanded bottom sliding slot forms on a side surface of one said clamping block without reaching another side surface opposite thereto.

6. The vise of claim 2, further including an adjusting mechanism which is for being adjustably disposed on a platform, the adjusting mechanism abutting against the pushing block and being capable of actuating the pushing block to move relative to the platform in a direction, the direction defined as a direction as same as the inclination direction toward the platform.

7. The vise of claim 2, further including a platform and an adjusting mechanism which is adjustably disposed on the platform, the adjusting mechanism abutting against the pushing block and being capable of actuating the pushing block to move relative to the platform in a direction, the direction defined as a direction as same as the inclination direction toward the platform.

8. The vise of claim 1, wherein the first restriction structure is a neck-expanded bottom sliding slot, and the second restriction structure is a head-neck protrusion.

9. The vise of claim 2, wherein two opposite sides of the pushing block respectively have one said pushing side, a number of the at least one clamping block is two, and the two pushing sides tilt in directions which are axially corresponded.

10. The vise of claim 9, further including an elastic mechanism, the elastic mechanism connected to the two clamping blocks.

11. The vise of claim 10, wherein the elastic mechanism includes at least one side board, at least two fixing members and at least one elastic member, each said side board has an open slot, one of the two fixing members fixes one said side board and one of two ends of one said elastic member to one said clamping block, and the other of the two fixing members fixes the other of the two ends of the elastic member to another said clamping block and is slidably arranged within the open slot.

12. The vise of claim 1, further including an elastic mechanism, the elastic mechanism connected to the pushing block and the clamping block.
